(19) United States
(12) Patent Application Publication
(10) Pub. No.: US 2012/0121053 A1
(43) Pub. Date: May 17, 2012

(54) Very Large Enhancements of Thermal Neutron Fluxes Resulting in a Very Large Enhancement of the Production of Molybdenum-99 Including Spherical Vessels

(76) Inventors: ROBERT E. SCHENTER, Portland, OR (US); Michael K. Korenko, Pasco, WA (US)

(21) Appl. No.: 12/649,915

(22) Filed: Dec. 30, 2009

Related U.S. Application Data
(63) Continuation-in-part of application No. 12/543,408, filed on Aug. 18, 2009.

(51) Int. Cl. G21G 1/06

(52) U.S. Cl. 376/158

(57) ABSTRACT

A large enhancement of neutron flux is realized when a primary target of D₂O and H₂O is contained in a vessel, is irradiated by an electron beam incident on a gamma converter and where the vessel is enclosed within a neutron reflector material including Nickel and Polyethylene. A very large enhancement of neutron flux is realized when a secondary target of LEU is mixed with the primary target resulting in a very large enhanced production of Molybdenum-99. The primary target and the secondary target is contained in cylindrical or spherical vessels.

### CONTINUATION IN PART APPLICATION

This application is a Continuation in Part pending from the parent application titled “Very Large Enhancements of Thermal Neutron Fluxes Resulting in a Very Large Enhancement of the Production of Molybdenum-99”, U.S. patent application Ser. No. 12/543,408 filed Aug. 18, 2009. Filed herewith is the original Declaration of the inventors, the Verified Statement Claiming Small Entity Status and the Power of Attorney.

### FIELD OF THE INVENTION

The present invention generally relates to neutron generators, and more particularly to a neutron generator employing an electron accelerator for producing thermal neutrons. More specifically, this invention relates to a method of enhancing the thermal neutron flux for the production of medical and industrial isotopes including Molybdenum-99 and other isotopes. Yet more specifically, this invention relates to a method of very large enhancements of thermal neutron fluxes due to the use a homogeneous mixture of D₂O and H₂O with

### BACKGROUND OF THE INVENTION

The efficient production of certain short-lived isotopes, including Molybdenum-99, requires a high flux of thermal neutrons. Reactors producing such isotopes experience outages which disrupt the availability of needed neutron sources. Alternatives to nuclear reactors, as a neutron source, include cyclotrons and electron accelerators. However, such systems capable of production of a high thermal flux have posed such expense and size so as to render them impractical for use in a clinical setting.

Known electron accelerators, capable of producing high energy neutrons, are large and impose high operating expenses. Additionally, neutrons of such energy require massive shielding and are not effectively thermalized. The patents and publications referred to herein are provided herewith in an Information Disclosure Statement in accordance with 37 CFR 1.97.

### SUMMARY OF THE INVENTION

The present invention is directed to a method of very large enhancements of thermal neutron fluxes resulting from the irradiation of a vessel (200) containing a homogeneous mixture of a solution of D₂O and H₂O, comprising a primary target (400) mixed with Low Enriched Uranium (LEU), comprising a secondary target (500), where the vessel (200) is enclosed with Nickel and or Polyethylene neutron reflector (600) material. In the preferred embodiment the source of irradiation is from an electron accelerator, indicated here as LINAC (100). An electron beam (120) irradiates a gamma converter (300) which is affixed to the vessel (200) for converting the electron beam (120) into photons for producing high energy neutrons in a photonuclear reaction between the photons and the photoneutron target, and for moderating the high energy neutrons to generate the thermal neutrons. The electron beam (120) has an energy level that is sufficiently low as to enable the material to moderate the high energy neutrons resulting from the photonuclear reaction. The receiving device is enclosed, with the exception of the path required for the electron beam (120) to irradiate the converter (300), in a material which reflects neutrons back into the photoneutron target thereby realizing an enhancement of the neutron flux to which the photoneutron target is exposed. In a preferred embodiment, a secondary target (500) of LEU is placed within the receiving device with a primary target (400), which, when radiated by the enhanced neutron flux, fissions thereby further and greatly enhancing the neutron flux. The use of LEU, as a secondary target (500), results in the production of useful isotopes including Molybdenum-99.

### BRIEF DESCRIPTION OF THE FIGURES

The foregoing and other features and advantages of the present invention will become more readily appreciated as the same become better understood by reference to the following detailed description of the preferred embodiment of the invention when taken in conjunction with the accompanying drawings, wherein:

FIGS. 1 and 2 are charts showing a large enhancement of neutron flux from the use of neutron reflector (600) of Nickel and Polyethylene as the neutron reflector (600) material used to completely surround the vessel (200).

FIG. 3 is a chart showing the neutron flux with very large enhancement resulting from the use of Nickel as the reflector (600) material at three levels of Low Enriched Uranium (LEU) enrichment.

FIG. 4 is a chart illustrating the enhanced production of Molybdenum-99 where Polyethylene is used as reflector (600) material completely surrounding the vessel (200).

FIGS. 5 and 6 are schematics of an apparatus for generating thermal neutrons in accordance with this disclosure illustrating a vessel (200) containing a primary target (400) and, in FIG. 6, both a primary target (400) and a secondary target (500).

FIG. 7 is a schematic of an apparatus for generating thermal neutrons in accordance with this disclosure illustrating a spherical vessel (200) containing a primary target (400) and a secondary target (500). Also illustrated is a cooling system (700) at the exterior of the vessel (200) where the exterior of the vessel (200) and the cooling system (700) is covered with Polyethylene (600). Also seen is shielding with Nickel (650) distal to the exterior of the vessel (200) illustrated here at the interior of a hot cell within which the vessel (200) is positioned.

FIG. 8 illustrates the results of an MCNPX keff (criticality) calculation (Casekz) for a spherical vessel containing D²O/Urnl (20 kgU-19% enrichment in U235) containing 400 liters, made of Zircaloy with a thickness of 0.635 cm. For the purpose of these calculations it is assumed that the vessel is surrounded by a jacket containing H²O with a thickness of 0.5 cm. Surrounding the H²O jacket is Polyethylene having a thickness of 10 cm. These results show the “safety” property that keff will not go above 0.99 regardless of the thickness of the Polyethylene.

### DETAILED DESCRIPTION OF THE INVENTION

The preferred embodiment of this disclosure is a “hybrid” system of an accelerator-subcritical reactor with a primary target (400) comprised of a solution of D₂O and H₂O with sufficient LEU, as a secondary target (500), homogeneously mixed with the primary target (400). The primary target (400) and secondary target (500) are contained in a vessel (200), formed for example from metals resistant to corrosion including Al, Stainless Steel or Zircaloy, which, in the preferred embodiment, is encased in reflectors of Polyethylene and or Nickel. In an alternative embodiment the vessel (200) may be spherical having a cooling system (700) at the exterior of the vessel (200). When the homogeneously mixed primary target (400) and secondary target (500) are irradiated there is a resulting very large enhancement in thermal flux and hence the production of Molybdenum-99. The disclosure herein, of a method of producing very large enhancements in thermal flux is realized by attention to the mass of U-235, the thicknesses of the reflector of Nickel and or Polyethylene and vessel geometry. This invention discloses combinations which produce a “resonance” effect and hence a very large enhancement in neutron thermal flux.

The presence of U-235 employed in the secondary target (500) plays a very important role. The disclosed mass of U-235 results in dramatically increased production of Molybdenum-99 because of the “high energy” neutrons created in the fission spectrum of 1 MeV-20 MeV. The primary target of D₂O and H₂O plays two very important roles. First, D2 provides the target for the required photoneutron effect. The primary target (400) of the D₂O and H₂O solution thermalizes photoneutrons and more importantly fission neutrons from U235 and U238.

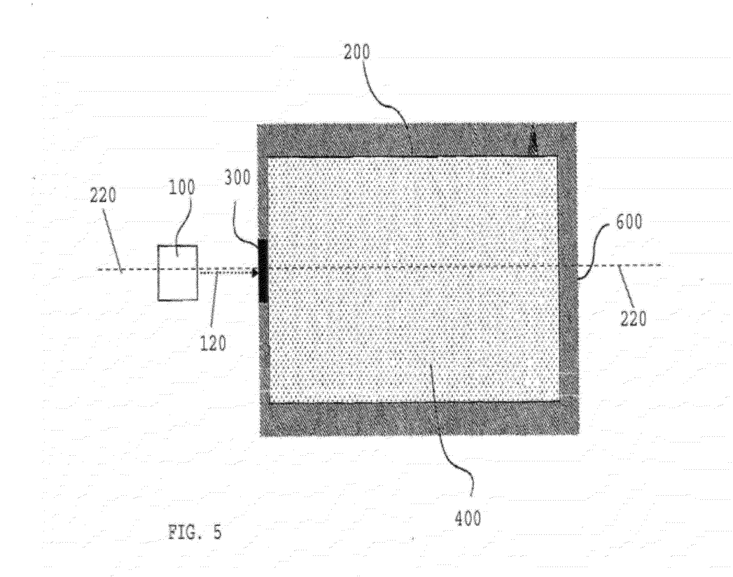

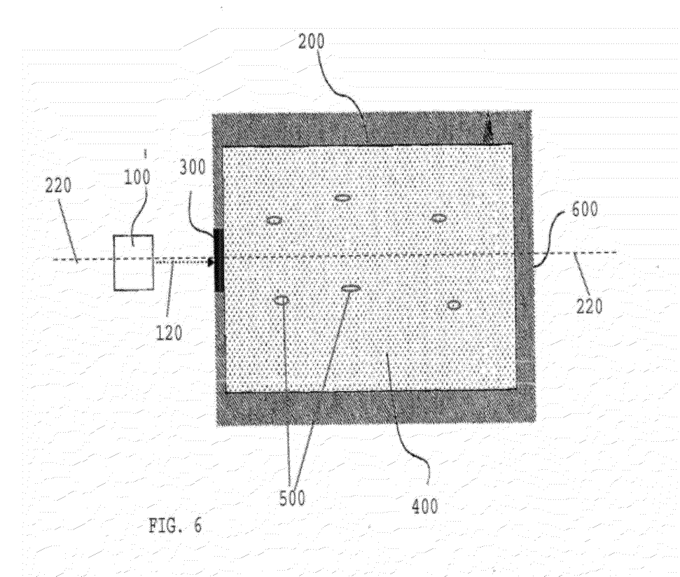

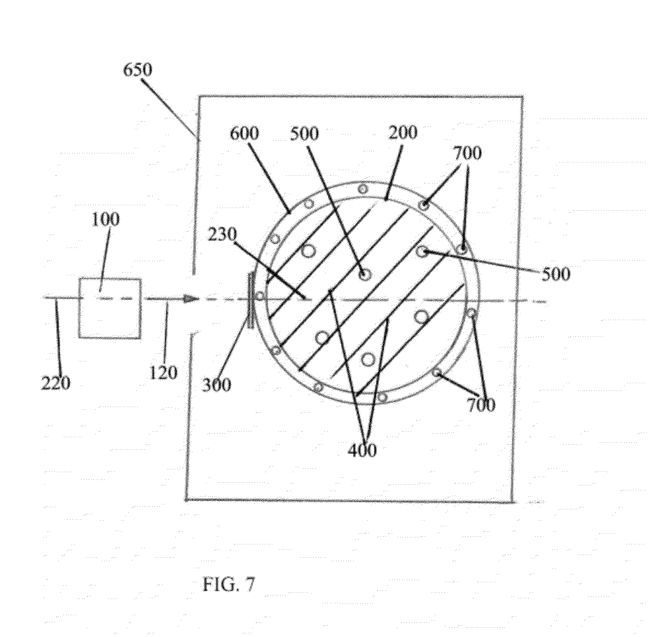

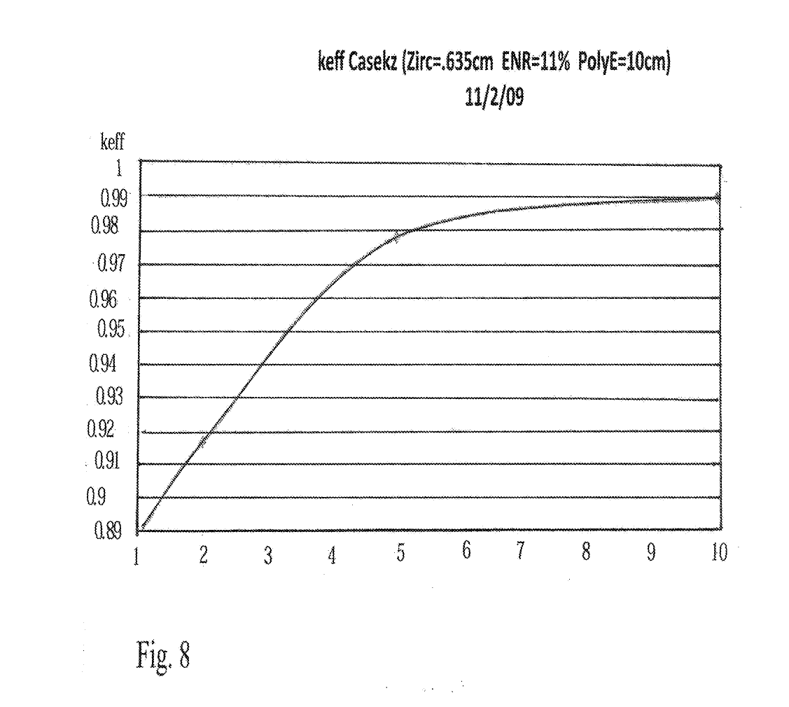

FIGS. 5 and 6 schematically illustrates a neutron generating device to accomplish the present method. Seen, as the preferred embodiment, is an electron linear accelerator (LINAC) (37) for producing an electron beam (120) which is incident on an gamma ray converter (300). Seen in FIG. 7, an alternative embodiment, is an accelerator (100) capable of producing an electron beam (120) of an energy sufficient to create greater than 2.25 MeV gamma rays. The gamma ray converter (300) is attached to a vessel (200) containing a neutron moderator, here the primary target (400) and comprising a solution of D₂O or of D₂O and H₂O. The electron beam (120) irradiation of the gamma converter (300) produces photons that are directed into the primary target (400) solution where thermal neutrons are generated. Also illustrated in FIG. 6 is a secondary target (500), comprising, for example, U-235 which is mixed within the primary target (400) solution. The preferred embodiment utilizes a LINAC (100) which has an electron beam (120) energy from approximately 5 MeV to approximately 30 MeV, but preferably in the range of approximately 5 MeV to 15 MeV, and an electron beam (120) current of approximately 0.8 to 1 mA or 1 to 10 kW for a 10 MeV electron beam (120). It is recognized, by those of ordinary skills with irradiation, that energy sources other than an LINAC (100) may be employed. However, for the reasons previously mentioned, the LINAC (100) is the preferred energy source. The vessel (200) is, in the preferred embodiment, a cylinder having a diameter and length with a longitudinal axis (220) along the vessel length. The electron beam (120) is coincident with the longitudinal axis (220).

In FIG. 7, an alternative embodiment, the accelerator or accelerators have an electron beam (120) energy from approximately 10 MeV to approximately 40 MeV, but preferably in the range of approximately 20 MeV to 30 MeV, and an electron beam (120) current of approximately 10 to 20 mA. In this alternative embodiment the preferred energy is 24 MeV at 10 mA. The vessel (200) is, in an alternative embodiment, a sphere having a diameter (230). The electron beam (120) is coincident with the diameter (230).

The gamma converter (300) is made of a material having an atomic number or Z of at least 26, but preferably higher than 70, for example, tantalum (Ta, Z=73) or tungsten (W, Z=74) or depleted uranium (U, Z=92). When the electron beam (120) is incident on the front surface of the converter (300), bremsstrahlung photons are produced as the electrons slow down in the converter. This process is most efficient in producing photons when the electrons are stopped in a material of high atomic number, such as Ta or W, for example, used in the preferred embodiment.

FIGS. 5 and 6 illustrates a vessel (200) for holding D₂O and H₂0. The vessel (200) is provided inside a neutron reflector (600) for reflecting escaping neutrons back into the vessel (200). The vessel (200) may be made of any material that holds water and is generally resistant to absorption of neutrons, including, for example Al. The vessel (200) may be any size and should be sufficiently large enough for a desired thermal neutron yield. Here the vessel may be cylindrical with a diameter range of 60 cm to 100 cm and a length range of 50 cm to 120 cm. Alternatively the vessel may have a rectangular cross section. For the preferred embodiment the vessel (200) geometry is cylindrical having a diameter of 100 cm and length of 100 cm. Higher neutron yield may be obtained in a larger vessel (200) of heavy water.

In an alternative embodiment, seen in FIG. 7, the vessel (200) exterior may be cooled with a cooling system (700) as an example. A cooling system (700) may be comprised of cooling coils circulating a cooling medium, for example water. The vessel (200) exterior and cooling system (700) are covered with a neutron reflector (600) material. The neutron reflector (600) material reflects and moderates neutrons. In the alternative embodiment the vessel is made of a material which is resistant to corrosion, holds water and is resistant to the absorption of neutrons. Such materials include stainless steel and Zircaloy. Where the vessel (200) is stainless steel the preferred metal is 316 L stainless steel. In this embodiment Zircaloy is the preferred material for the vessel (200). The neuron reflector (600), in this alternative embodiment, is Polyethylene covering the vessel (200) exterior and cooling system (700). The vessel (200) geometry is spherical having a volume from 200 to 600 liters with a preferred volume from 350 to 400 liters and, ultimately preferred at a volume of 375 liters. In this embodiment the vessel (200) wall thickness is ⅛th to ¾th inches with an optimum range of ¼ to ½ inches and ultimately a preferred wall thickness of ¼ inches.

The reflector (600) can be of any neutron reflecting material such as, for example, graphite, Polyethylene, Nickel or steel. In the preferred embodiment, the reflector (600), when Polyethylene, has a thickness of approximately 1.5 cm to 6.0 cm and when Nickel has a thickness of 1.0 cm to 4.0 cm. The thickness of the reflector (600) may vary depending on the size of the photoneutron primary target (400) of D₂O and H₂O contained within the vessel (200). A different reflector (600) material may be used on the top or bottom of the vessel (200) than on the radial side of the vessel. A sample of the primary target (400) or of the mixture of the primary target (400) and the secondary target (500) can be introduced and withdrawn, as known to those of ordinary skills in radiation arts, via a delivery tube from the vessel (200).

in the alternative embodiment the reflector (600) Polyethylene covers the vessel (200) exterior and cooling system (700), is of a thickness range of 1 to 10 cm with an optimum thickness of 2 to 4 cm. In this alternative embodiment neutron reflector (650) material of Nickel is affixed distal to the reflector (600) material and vessel (200) and may be affixed at the interior of the hot cell. The Polyethylene reflector (600) at the exterior of the vessel (200) and covering the cooling system (700) may be applied via spray. It is recognized that Polyethylene is both a neutron reflector and a moderator.

In operation, the secondary target (500) to be irradiated with thermal neutrons is introduced into the neutron generating vessel (200). The LINAC (100) is set by a control device to generate an electron beam (120) having the desired energy level, which is converted into photons by the gamma ray converter (300). The photons are injected into the vessel (200), where neutrons are produced through a photonuclear reaction with the primary target (400) comprised of a solution of heavy water and light water. In the present invention, neutrons are produced in a photonuclear reaction in deuterium D2. Deuterium has a low photonuclear threshold energy of 2.23 MeV. Thus, photons created from the LINAC (100) having electron energies in the range of approximately 5 MeV-15 MeV are sufficient to cause a photonuclear reaction in heavy water and generate high energy neutrons. The high energy neutrons are then slowed down, or moderated, to thermal energies by heavy water. Because of its small neutron absorption cross section and low effective atomic mass, heavy water functions also as a moderator. The thermal neutrons are then captured by the sample, here the secondary target (500) comprised preferably of LEU, which is converted to Molybdenum-99 and other isotopes.

This invention is the method of creating large and very large enhancements of thermal neutron fluxes. The method for creating large enhancements is by the use of an electron accelerator LINAC (100) irradiating, with an electron beam (120), a gamma ray converter (300) with the resulting gamma ray radiation of a primary target (400) of D₂O and H₂O contained within a vessel (200) which is enclosed within a neutron reflector (600) of either Polyethylene or Nickel. Further, the creation of very large enhancements is of the neutron flux is by the incorporation of a secondary target (500) of LEU into the D₂O/H₂O solution.

From the foregoing description, it should be understood that a thermal neutron generator capable of greatly enhanced neutron flux by the use of reflectors (48) when the primary target (400) is a solution of D₂O and H₂O and, further, capable of a very great enhancement of neutron flux, within the primary target (400), when a secondary target (500) of enriched Uranium is homogeneously mixed with the primary target (400). The effect of creating a very great enhancement of neutron flux when a secondary target (500) is present is to increase the efficiency of production of useful isotopes including Molybdenum-99. Here, for vessel (200) sizes expected the secondary target (500) will be within a range of LEU from 18 kg to 25 kg. The secondary target (500) of LEU is a solution with U-235 ions in solution. 20 kg of Uranium, at 19% LEU, contains 3.8 kg U-235. In the preferred embodiment the primary target (400) of a solution of D₂O and H₂O combined with a secondary target (500) of LEU will have LEU enriched in the range of 15% to 19% U-235.

In the alternative embodiment the primary target (400) is a solution of D₂O and H₂O in the range of 80% to 100% D²0 and 0% to 20% H²O and is preferred to be maintained at 90% D²0. In this alternative embodiment the primary target (400) of a solution of D₂O and H₂O combined with a secondary target (500) of LEU will have LEU enriched in the range of 11% to 19% U-235 with preferred LEU enrichment at 15% U-235. The total Uranium concentration will be less than or equal to 50 grams/liter with the total Uranium content with a range of 10 to 20 Kg.

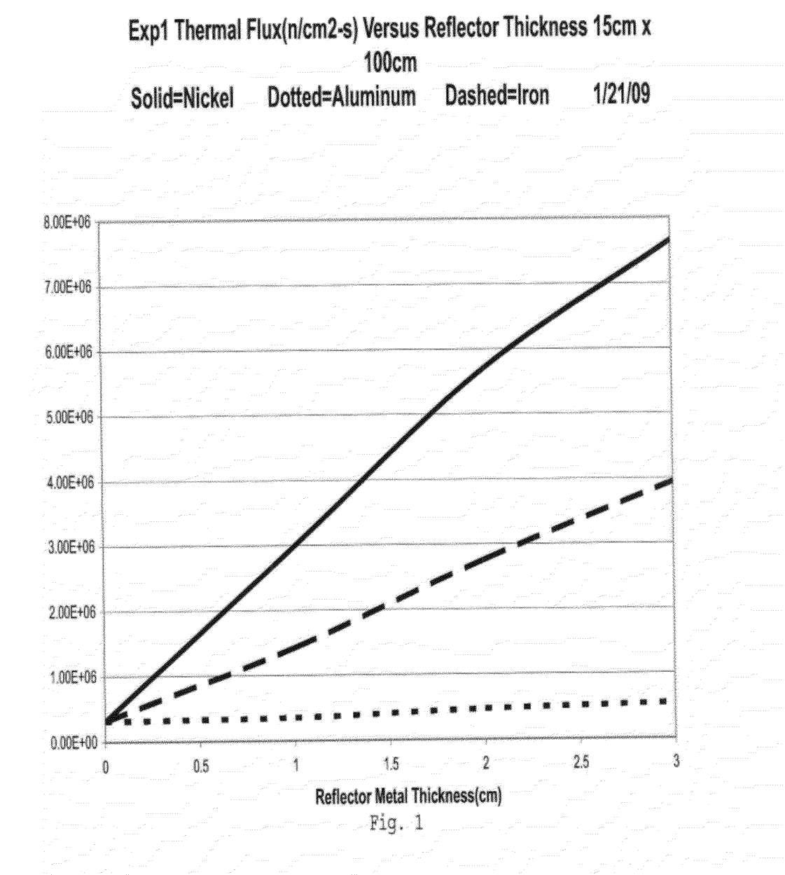

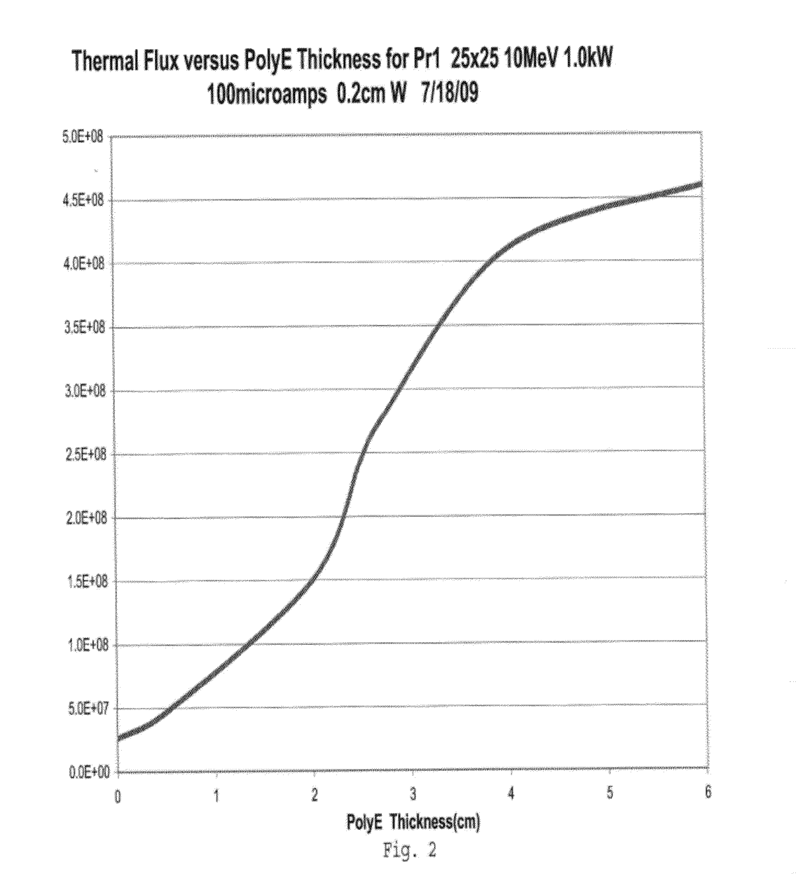

Results of MCNPX Code calculations showing the effect of Nickel and Polyethylene reflection are seen in FIGS. 1 and 2. In FIG. 1 three curves are seen for Nickel, Al and Fe. Nickel shows the largest enhancement of thermal neutron flux of a factor of 15 increase in thermal flux as reflector (600) of Nickel increases in thickness from 0.0 cm to 3.0 cm. Also seen in FIG. 1 are curves for Al and Fe illustrating a lack of enhanced thermal flux. FIG. 2 illustrates thermal flux enhancement using Polyethylene where the thermal flux is enhanced by a factor of 9 for an increase in the reflector (600) thickness from 0.0 cm to 6.0 cm.

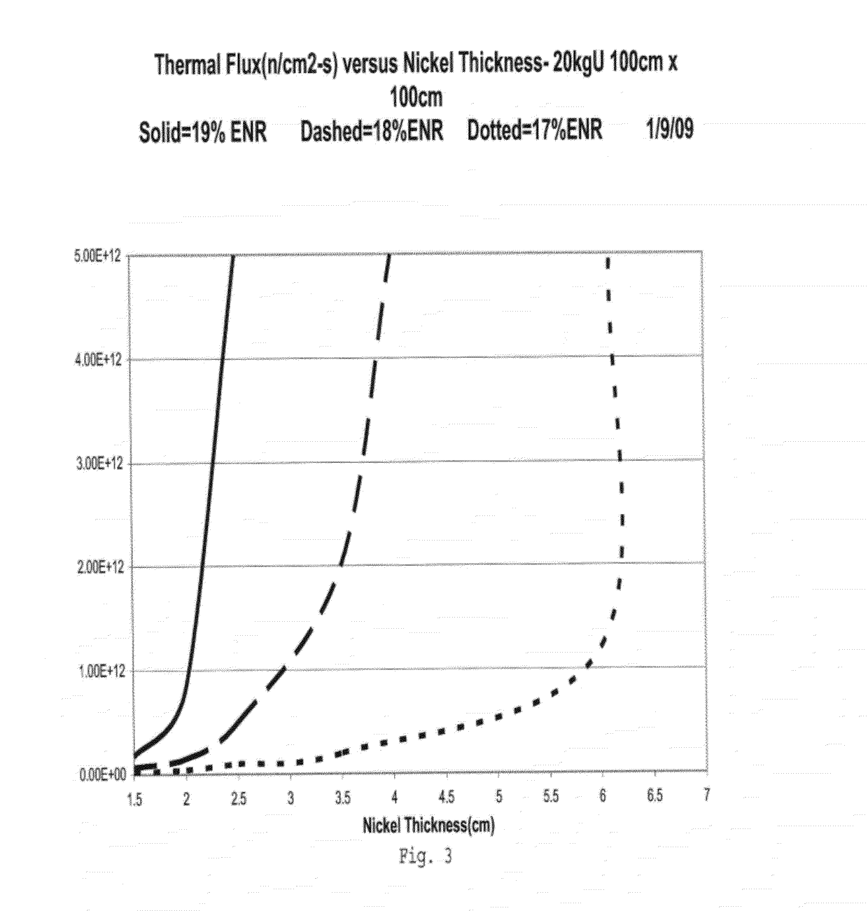

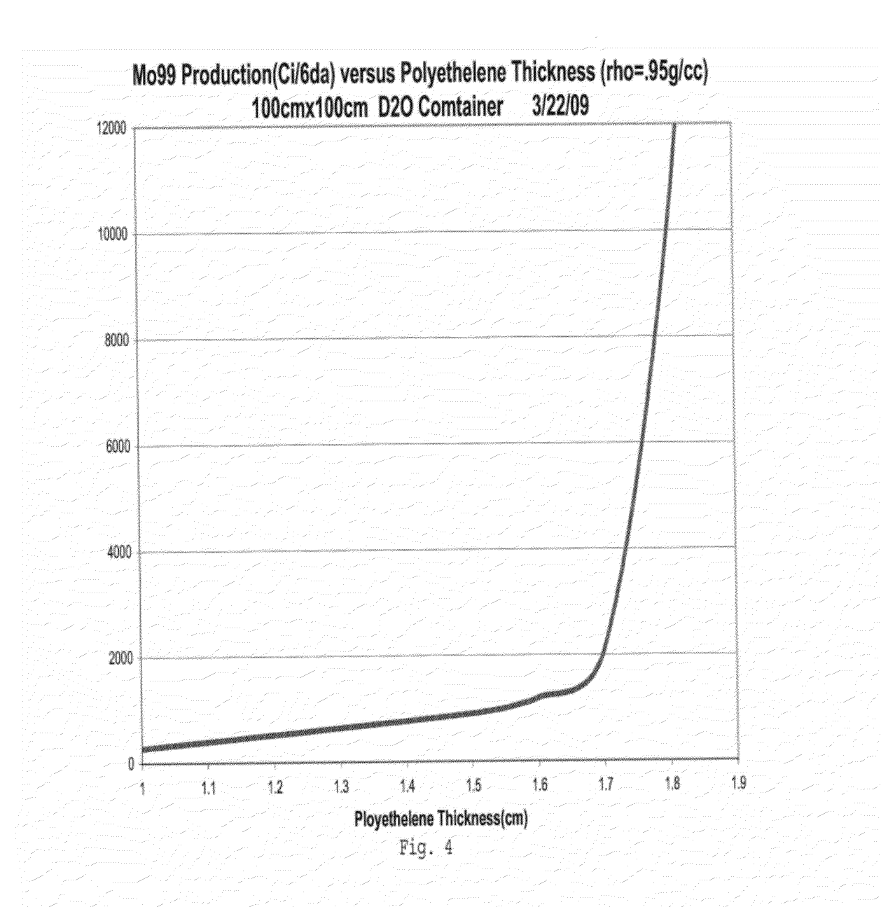

When a secondary target (500) of Uranium is homogeneously mixed with the primary target (400) of D₂O and H₂O, the use of a reflector (600) of Nickel shows a very large enhancement in FIG. 3. FIG. 3 is illustrative of the very large enhancement realized where the secondary target (500) is 20 kg of Uranium mixed with the primary target (400) of Heavy Water. FIG. 3 shows three curves for 17%, 18% and 19% LEU. Seen, in FIG. 3, is the very large enhancement of thermal flux from low values to 5×10¹² n/cm² for three different thicknesses reflector (600) of Nickel. The lowest enrichment requires reflector (600) Nickel thickness of about 6 cm. The 18% enrichment requires about 4 cm of Nickel and the 19% enrichment requires about 2.3 cm of Nickel to reach the highest thermal flux values. The LINAC (100) operation is at 1 mA (10 kw) for energy of a 10 MeV electron beam (120) incident on a W gamma converter (300) of thickness 0.2 cm and 5 cm in diameter. FIG. 4 illustrates the production of Molybdenum-99 when reflector (600) is comprised of Polyethylene. In FIG. 4 a Polyethylene reflector (600) of thickness from 1.0 cm to 1.8 cm is illustrated with the production of Molybdenum-99 indicated, with the reflector (600) at 1.8 cm, of 12,000 6-day curies. Here the vessel (200) is 100 cm in diameter×100 cm in length with a wall of 0.2 cm thick Al containing a primary target (400) solution of D₂O and H₂O. The primary target (400), for the charts of FIGS. 3 and 4, is 100% D₂O. However, a very large enhancement of neutron flux will be expected with the primary target (400) comprised of a mixture of D₂O and H₂O within a range of H₂O at 10 to 25%. The expected range of enrichment of U-235, for a very large enhancement of neutron flux is 15%-19% LEU.

In the alternative embodiment the vessel (200) will be water cooled. In the alternative embodiment the converter (300) will have a thickness in the range of 0.1 to 0.6 cm and is preferred at 0.35 cm.

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims. Various features of the invention are set forth in the appended claims.

I claim:

1. A Method of producing very large enhancements of thermal neutron fluxes comprising:
a. establishing a primary target (400) of a D₂O and H₂O solution contained within a vessel (200); shielding the vessel (200); the vessel (200) is cylindrical or cubical and, where cylindrical having a diameter and length with a longitudinal axis (220) centered along the vessel length and where cubical, with a rectangular cross section, having a width, height and length with a longitudinal axis (220) centered along the vessel length;
b. producing an electron beam (120), with a linear electron accelerator LINAC (100), with energy of 5 MeV-30 MeV and preferably from 10 MeV-30 MeV; the electron beam (120) irradiating a W, Ta, or Pb gamma ray converter (300) producing gamma rays of 0 MeV-30 MeV; the electron beam (120) is coincident with the longitudinal axis (220);
c. irradiating the primary target (400), with said gamma rays, producing neutrons which pass through the primary target (400) losing energy by interacting with Hydrogen and D₂O and thermalizing thereby producing a neutron flux with energies from thermal to 10 MeV and thereby producing Molybdenum-99 and other medical and industrial isotopes;
d. establishing a secondary target (500) of LEU contained within the vessel (200); the neutron flux irradiating the secondary target (500) of LEU producing Molybdenum-99 and other medical and industrial isotopes;
e. encompassing the vessel (200) with a neutron reflector (600) material, the reflector (600) material intermediate the shielding and the vessel (200) and consisting of Nickel or Polyethylene or of a combination of Nickel and Polyethylene or other materials selected from the group consisting of Nickel, Polyethylene, steel, or Graphite; the reflector (600) material reflects the neutrons back into the primary target (400); the reflection creating a very large enhancement of the neutron flux; the very large enhancement of neutron flux irradiating the secondary target (500) resulting in a very large enhancement of the production of Molybdenum-99 and other isotopes.

2. A Method of producing very large enhancements of thermal neutron fluxes comprising:
a. containing a primary target (400) of D₂O and H₂O solution within a vessel (200);
b. producing an electron beam (120) having an energy of 5 MeV-30 MeV;
c. irradiating a gamma ray converter (300) affixed to the vessel (200), with the electron beam (120), creating gamma rays of 0-30 MeV; irradiating, with the gamma rays, the primary target (400) producing neutrons which pass through the primary target (400) losing energy by interacting with H₂O and D₂O and thermalizing thereby producing a neutron flux primarily in the thermal and epithermal energy regions;
d. encompassing the vessel (200) with a neutron reflector (600) material with the neutron reflector (600) completely surrounding the vessel (200), with the exception of the path from the LINAC (100) electron beam (120) to the gamma ray converter (300); the neutron reflector (800) material reflecting neutrons back into the primary target (400); the reflection creating a large enhancement of the neutron flux; the large enhancement of neutron flux irradiating the primary target (400) and greatly enhancing the production of Molybdenum-99 and other isotopes;
e. mixing a secondary target (500) of LEU with the primary target (400); the combination of the primary target (400), the energy of the electron beam (120), the secondary target (500) and the neutron reflector (600) material “resonates” thereby creating a very great enhancement of neutron flux.

3. The method of claim 2 further comprising:
a. the H₂O in the primary target (400) comprises a percentage of the primary target (400) of from 0.0% to 40%;
b. the electron beam is produced with a linear electron accelerator LINAC (100); the energy of the electron beam (120) is from 10 MeV-30 MeV;
c. the gamma ray converter (300) is selected from the group consisting of W, Ta or Pb;
d. the neutron reflector (600) material is selected from the group consisting of graphite, Polyethylene, steel or Nickel or a combination of said materials;
e. the vessel (200) is cylindrical or cubical, and, where cylindrical having a diameter and length and where cubical having a width, height and length; the vessel (200) having a longitudinal axis (220) centered on the vessel and along the vessel (200) length; the electron beam (120) is coincident with the longitudinal axis (220);
f. shielding the vessel (200).

4. The method of claim 3 further comprising:
a. the percentage of the primary target (400) comprised of H₂O is 25%;
b. the gamma ray converter (300) is W and is 0.2 cm thick and 0.5 cm in diameter;
c. the neutron reflector (600) material is Polyethylene or Nickel;
d. the vessel (200), where a cylinder, has a diameter in the range of 60 cm to 100 cm and with a length of 50 cm to 120 cm.

5. The method of claim 4 further comprising:
a. where the reflector (600) material is Nickel, the Nickel is from 1.0 cm to 6.0 cm in thickness; where the reflector (600) material is Polyethylene, the thickness of the Polyethylene is from 2.0 cm to 20.0 cm;
b. the vessel (200) is 100 cm in diameter×100 cm in length with a wall of 0.2 cm thick Al.

6. The method of claim 2 further comprising:
a. the H₂O in the primary target (400) comprises a percentage of the primary target (400) of from 0.0% to 40%;
b. the electron beam is produced with a linear electron accelerator LINAC (100); the energy of the electron beam (120) is from 10 MeV-30 MeV;
c. the gamma ray converter (300) is selected from the group consisting of W, Ta or Pb;
d. a secondary target (500) of LEU is contained within the vessel (200);
e. the neutron reflector (600) material is selected from the group of graphite, Polyethylene, steel or Nickel or a combination of said materials;
f. the vessel (200) is cylindrical or cubical, and, where cylindrical having a diameter and length and where cubical having a width, height and length; the vessel (200) having a longitudinal axis (220) centered on the vessel and along the vessel (200) length; the electron beam (120) is coincident with the longitudinal axis (220);
g. shielding the vessel (200);
h. the combination of the primary target (400), the energy of the electron beam (120), the secondary target (500) and the neutron reflector (600) material “resonates” thereby creating a very great enhancement of neutron flux.

7. The method of claim 6 further comprising:
a. the percentage of the primary target (400) comprised of H₂O is about 25%;
b. the gamma ray converter (300) is W and is 0.1 cm to 0.3 cm thick and 0.5 cm in diameter;
c. the vessel (200) is a cylinder with a diameter in the range of 60 cm to 100 cm and with a length in the range of 50 cm to 120 cm.
d. the neutron reflector (600) material is Polyethylene or Nickel;
e. the secondary target (500) of LEU is as solution in the range of 18 kg to 25 kg and is in the range of 15% to 19% enriched LEU.

8. The method of claim 7 further comprising:
a. where the reflector (600) material is Nickel, the Nickel is from 2.0 cm to 8.0 cm in thickness; where the reflector (600) material is Polyethylene, the thickness of the Polyethylene is from 2.0 cm to 20.0 cm.

9. The method of claim 8 further comprising:
a. where the percentage of the primary target (400) comprised of H₂O is about 25% and the reflector (600) material is Nickel with a thickness of 2.0 cm to 6.0 cm and the U-235 is enriched in the range of about 15% to 19% enriched LEU, the production of Molybdenum-99 is enhanced by a factor of about 100 to 1000; where the percentage of the primary target (400) comprised of H₂O is 25% and the reflector (600) material is Polyethylene with a thickness of 2.0 cm to 8.0 cm, the production of Molybdenum-99 is enhanced by a factor of about 100 to 1000;
b. the LINAC (100) operation is at about 1.0 mA at about 10 kw for energy of a 10 MeV electron beam (120) incident on the W gamma converter (300) of thickness 0.2 cm and 5 cm in diameter.

10. The method of claim 9 further comprising:
a. when the secondary target (500) is LEU and is homogeneously mixed with the primary target (400), there is a very large enhancement of thermal flux to about 5×10¹² n/cm² where the reflector (600) is Nickel with a range of thickness from about 6.0 cm thickness to 2.0 cm thickness when the respective secondary target (500) of U-235 is enriched in the range of about 17% enriched LEU to 19% enriched LEU;
b. the LINAC (100) operation is at about 1 mA (10 kw) for energy of a 10 MeV electron beam (120) incident on the W gamma converter (300) of thickness 0.2 cm and 5 cm in diameter.

11. The method of claim 10 further comprising:
a. when the secondary target (500) is LEU and is homogeneously mixed with the primary target (400), there is a very large enhancement of thermal flux to about 5×10¹² n/cm² where the reflector (600) is Nickel with a thickness of about 6 cm and the secondary target (500) of U-235 is enriched to about 17% enriched LEU or, where the reflector (600) is Nickel with a thickness of about 4.0 cm and the secondary target (500) of U-235 is enriched to about 18% enriched LEU or, where the reflector (600) is Nickel with a thickness of about 3.0 cm and the secondary target (500) of U-235 is enriched to about 19% enriched LEU.

12. The method of claim 9 further comprising:
a. when the secondary target (500) is LEU and is mixed with the primary target (400), there is a very large enhancement of thermal flux from low values to 5×10¹² n/cm² where the reflector (600) is Polyethylene of thickness from about 1.0 cm to 2.0 cm.

13. The method of claim 12 further comprising:
a. the production of Molybdenum-99 indicated, with the reflector (600) of Polyethylene of about 2.0 cm thickness, of 12,000 6-day curies;
b. the vessel (200) is 100 cm in diameter×100 cm in length with a wall thickness of 0.2 cm thick Al;
c. the secondary target (500) is about 20 kg Uranium.

14. A Method of producing very large enhancements of thermal neutron fluxes comprising:
a. containing a primary target (400), in solution, within a vessel (200); mixing a secondary target (500), in solution, with the primary target (400);
b. irradiating, with gamma rays, the primary target (400); the secondary target (500) comprising a material which fissions when subjected to thermal or epithermal neutrons;
c. encompassing the vessel (200) with a neutron reflector (600) material; the neutron reflector (600) material reflecting neutrons back into the primary target (400); the reflection creating a large enhancement of the neutron flux; the large enhancement of neutron flux irradiating the primary target (400) and greatly enhancing the production of Molybdenum-99 and other isotopes;
d. periodically extracting Molybdenum-99 and other isotopes from the vessel (200).

15. The method of claim 14 further comprising:
a. the primary target is a D₂O and H₂O solution;
b. the gamma rays irradiating the primary target (400) producing neutrons which pass through the primary target (400) losing energy by interacting with H₂O and D₂O and thermalizing thereby producing a neutron flux primarily in the thermal and epithermal energy regions;
c. the secondary target (500) comprised of LEU;
d. the neutron reflector (600) completely surrounds the vessel (200), with the exception of the path from the accelerator (100) electron beam (120) to the gamma ray converter (300);
e. the irradiation of the combination of the primary target (400) and the secondary target (500) surrounded by the neutron reflector (600) material “resonates” thereby creating a very great enhancement of neutron flux;
f. an external neutron reflector (650) installed distal to the vessel (200).

16. The method of claim 15 further comprising:
a. the primary target (400) is 80% to 100% D²O and 0% to 20% H²O; the gamma rays are produced by irradiating a gamma ray converter (300), which is affixed to the vessel (200), with an electron beam (120);
b. the gamma ray converter (300) is selected from the group consisting of W, Ta or U;
c. the neutron reflector (600) and the external neutron reflector (650) material is selected from the group consisting of graphite, Polyethylene, steel or Nickel or a combination of said materials;
d. the vessel (200) is spherical having a diameter (230); the electron beam (120) is coincident with the diameter (230) and orthogonal to the gamma ray converter (300);
e. cooling the converter (300) and the vessel (200) at the exterior of the vessel (200) with a cooling system (700); shielding the vessel (200).

17. The method of claim 16 further comprising:
a. the percentage of the primary target (400) comprised of D₂O is 100%;
b. the electron beam is produced with an accelerator (100); the energy of the electron beam (120) is from 20 MeV-30 MeV;
c. the neutron reflector (600) material is Polyethylene; the external neutron reflector (650) is Nickel;
d. the cooling system (700) is intermediate the neutron reflector (600) and the vessel (200) exterior.

18. The method of claim 17 further comprising:
a. the percentage of the primary target (400) comprised of D₂O is 90%; where the reflector (600) material is Polyethylene, the Polyethylene is from 1.0 cm to 10.0 cm in thickness;
b. the vessel (200) contains 200 to 600 liters; the vessel (200) is made of corrosive resistant metals having a wall thickness of ⅛th to ¾ inch;
c. the electron beam (120) is produced by an accelerator having an energy of 10 MeV-40 MeV; the irradiation of the converter creating gamma rays of 0-30 MeV; the gamma ray converter (300) is 0.1 to 0.6 cm thick;
d. the converter (300) is made from W and is 0.35 cm thick and 0.5 cm in diameter.

19. The method of claim 18 further comprising:
a. where the reflector (600) material is Polyethylene, the Polyethylene is from 2.0 cm to 4.0 cm in thickness;
b. the metals comprising the vessel (200) include stainless steel and Zircaloy; the vessel (200) contains 350 to 400 liters with a wall thickness of ¼ inch to ½ inch.

20. The method of claim 19 further comprising:
a. the vessel (200) contains 375 liters;
b. the Uranium concentration within the vessel (200) is less or equal to 50 grams per liter; the total Uranium content is 10 to 20 kg; the LEU 235 concentration is 11% to 19.9%.

21. The method of claim 20 further comprising:
a. where the external reflector (650) material is Nickel, the Nickel is ¼ inch in thickness;
b. the vessel (200) wall thickness is ¼ inch;
c. the LEU 235 concentration is 15%.

22. A Method of producing very large enhancements of thermal neutron fluxes comprising a vessel (200) containing a primary target (400) fluid which, when irradiated with gamma rays produces and moderates neutrons to thermal or epithermal neutrons, and a secondary target (500) fluid having at least one radioactive constituent which fissions effectively when irradiated by thermal or epithermal neutrons; the vessel (200) comprising a chamber enclosed in a neutron reflector material (600) with an attached gamma converter (300); the converter (300) is irradiated by an accelerator (100) electron beam (120) of an energy sufficient to create greater than 2.25 MeV gamma rays; the gamma rays irradiating the primary target (400) and the secondary target (500) fluid; the neutron reflector material (600) reflecting neutrons back into the vessel (200); a vessel (200) chamber adapted for periodic extracting of a portion of the irradiated constituent of the primary target (400) and the secondary target (500); a vessel (200) chamber for periodic insertion of a primary target (400) and secondary target (500) fluid having properties of the said primary target (400) and the secondary target (500).
